(19) United States
(12) Patent Application Publication
(10) Pub. No.: US 2017/0187763 A1
(43) Pub. Date: Jun. 29, 2017

(54) STREAMING SERVICE SYSTEM, STREAMING SERVICE METHOD AND CONTROLLER THEREOF

(71) Applicants: Industrial Technology Research Institute, Hsinchu (TW); National Chiao Tung University, Hsinchu City (TW)

(72) Inventors: Ming-Hung Hsu, Taoyuan City (TW); Chien-Chao Tseng, Hsinchu City (TW); Min-Cheng Chan, Taichung City (TW); Hsing-Liang Ku, Kaohsiung City (TW); Ming-Hao Chou, New Taipei City (TW)

(21) Appl. No.: 14/983,560

(22) Filed: Dec. 30, 2015

(30) Foreign Application Priority Data
Dec. 24, 2015 (TW) 104143652

(51) Int. Cl. H04L 29/06; H04L 12/18

(52) U.S. Cl. CPC H04L 65/4069; H04L 12/18

(57) ABSTRACT

The disclosure provides a streaming service system, a streaming service method and a controller thereof The streaming service system includes a plurality of switch nodes, a plurality of surrogate servers, a content management apparatus and a controller. The switch nodes are connected, and the surrogate servers are respectively connected to one of the switch nodes. The controller is connected to the switch nodes and communicates with the content management apparatus. The content management apparatus provides server information of the surrogate servers to the controller. When a first client apparatus is joined to a streaming group, the content management apparatus informs the controller. Further, the controller selects a first surrogate server from the surrogate servers, and sets at least a portion of the switch nodes to adjust a multicast tree. The first surrogate server transmits streaming packets to the first client through a first transmission route of the multicast tree.

### CROSS-REFERENCE TO RELATED APPLICATION

This application claims the priority benefit of Taiwan application serial no. 104143652, filed on Dec. 24, 2015. The entirety of the above-mentioned patent application is hereby incorporated by reference herein and made a part of this specification.

### TECHNICAL FIELD

The disclosure relates to a streaming service system, a streaming service method and a controller thereof.

### BACKGROUND

Along with development of electronic technology and communication technology, more and more video and audio content is shared on the Internet through a streaming technique, and users may view video audio data such as movies, TV series or news programs, etc., through various smart mobile devices or computer devices.

On the Internet, the video and audio content is, for example, shared to group members through a group manner according to a multicast technique. Generally, the multicast technique shares the aforementioned video and audio content to the group members on a multicast network through a multicast address. An Internet group management protocol (IGMP) is provided to effectively manage and maintain the group members of a multicast group. In detail, under the IGMP, any group member may inform a multicast router before joining or leaving the multicast group. On the other hand, if a switch supporting an IGMP snooping function is adopted to assist transmitting the video and audio content to the group members of the multicast group, the switch may further remember transmission ports corresponding to the group members, such that the switch may adopt a multicast mode to replace a broadcast mode for transmitting the video and audio content.

However, when the multicast technique is implemented on the conventional Internet, transmission of the video and audio content is not guaranteed to satisfy a demand of quality of service (QoS), and a link bandwidth cannot be effectively used. In more detail, a transmission network within the multicast group does not necessarily meet a bandwidth requirement on video and audio streaming, and a suitable video and audio source cannot be selected. Moreover, limited by a spanning tree protocol (STP), redundant links between the switches cannot be effectively used to transmit the video and audio content.

According to the above description, it still one of the goals of effort for the technicians in the field to provide a better streaming service system and a streaming service method.

### SUMMARY

The disclosure is directed to a streaming service system, a streaming service method and a controller thereof, through which transmission of video and audio content satisfies a requirement of the basic bandwidth, and a link bandwidth is effectively used.

An embodiment of the disclosure provides a streaming service system including a plurality of switch nodes, a plurality of surrogate servers, a content management apparatus and a controller. The switch nodes are connected, and the surrogate servers are respectively connected to one of the switch nodes. The controller is connected to the switch nodes and communicates with the content management apparatus. The content management apparatus provides server information of the surrogate servers to the controller. When a first client apparatus is joined to a streaming group, the content management apparatus informs the controller, and the controller selects a first surrogate server from the surrogate servers, and sets at least a portion of the switch nodes to adjust a multicast tree. The first surrogate server transmits streaming packets to the first client apparatus through a first transmission route of the multicast tree.

An embodiment of the disclosure provides a streaming service method, which is adapted to a streaming service system. The streaming service system includes a plurality of switch nodes that are connected, a plurality of surrogate servers respectively connected to one of the switch nodes, a content management apparatus and a controller. The controller is connected to the switch nodes, and communicates with the content management apparatus. The streaming service method includes following steps. The content management apparatus provides server information of the surrogate servers to the controller. The content management apparatus receives a subscribing request transmitted by a first client apparatus. The content management apparatus transmits a connection request to the controller after receiving the subscribing request. The controller selects a first surrogate server from the surrogate servers after receiving the connection request, and sets at least a portion of the switch nodes to adjust a multicast tree. The controller transmits back a connection response to the content management apparatus. The first surrogate server transmits streaming packets to the first client apparatus through a first transmission route of the multicast tree.

An embodiment of the disclosure provides a controller, which is adapted to a streaming service system. The streaming service system includes a plurality of switch nodes that are connected, a plurality of surrogate servers respectively connected to one of the switch nodes and a content management apparatus. The controller includes a communication interface, a storage unit and a processor. The communication interface communicates with the content management apparatus, and the switch nodes are connected to the communication interface. The processor is coupled to the communication interface and the storage unit. The content management apparatus provides server information of the surrogate servers to the controller, and the controller stores the server information to the storage unit. When a first client apparatus is joined to a streaming group, the content management apparatus informs the controller. The processor of the controller selects a first surrogate server from the surrogate servers, and sets at least a portion of the switch nodes to adjust a multicast tree, such that the first surrogate server transmits streaming packets to the first client apparatus through a first transmission route of the multicast tree.

According to the above descriptions, in the streaming service system, the streaming service method and the controller provided by the embodiments of the disclosure, when the client apparatus is joined to the streaming group, the controller adjusts the multicast tree, such that the streaming packets can be transmitted between the client apparatus and the surrogate server through the transmission route of the multicast tree. Moreover, when the client apparatus leaves the streaming group or in a case of the network congestion, the controller further adjusts the multicast tree to cancel or adjust the transmission route between the client apparatus and the surrogate server. With assistance of the controller, transmission of video and audio streaming may satisfy a requirement of basic bandwidth. On the other hand, the transmission route between the client apparatus and the surrogate server may cope with a demand of the shortest route.

In order to make the aforementioned and other features and advantages of the disclosure comprehensible, several exemplary embodiments accompanied with figures are described in detail below.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic diagram of a streaming service system according to an embodiment of the disclosure.

FIG. 2A is a flowchart illustrating a streaming service method according to an embodiment of the disclosure.

FIG. 2B is a flowchart illustrating a streaming service method according to another embodiment of the disclosure.

FIGS. 3A-3B are flowcharts illustrating method for selecting a first surrogate server and adjusting a multicast tree according to an embodiment of the disclosure.

FIGS. 4A-4E are schematic diagrams of selecting a first surrogate server and adjusting a multicast tree according to an embodiment of the disclosure.

FIGS. 5A-5C are schematic diagrams of selecting a first surrogate server and adjusting a multicast tree according to an embodiment of the disclosure.

FIG. 6A is a flowchart illustrating a streaming service method according to still another embodiment of the disclosure.

FIG. 6B is a flowchart illustrating a streaming service method according to still another embodiment of the disclosure.

FIG. 7A and FIG. 7B are schematic diagrams of a multicast tree pruning procedure according to an embodiment of the disclosure.

FIG. 8 is a schematic diagram of determining a link congestion to adjust a transmission route according to an embodiment of the disclosure.

### DESCRIPTION OF EMBODIMENTS

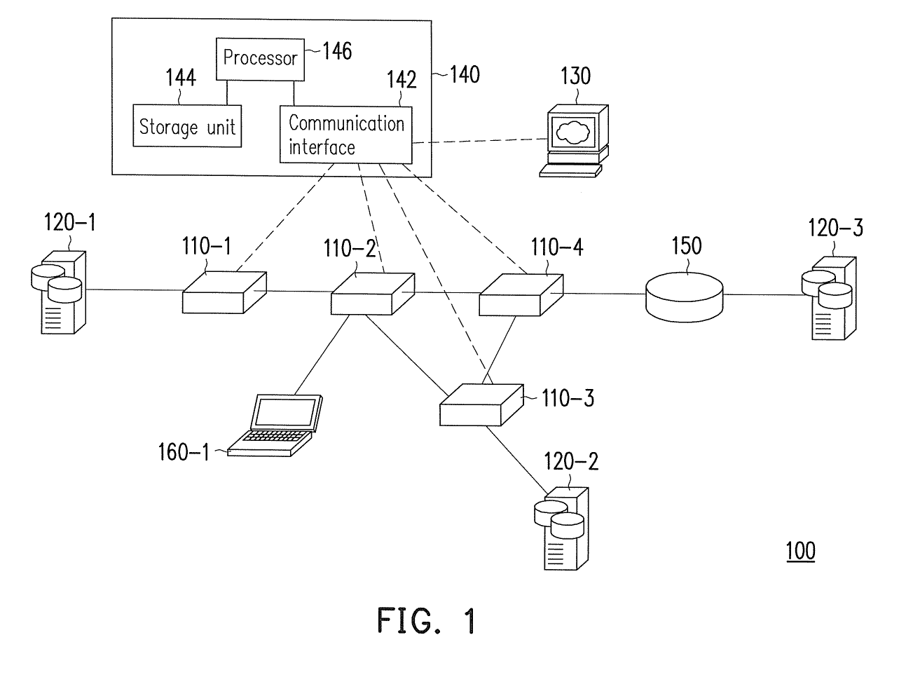

FIG. 1 is a schematic diagram of a streaming service system according to an embodiment of the disclosure. Referring to FIG. 1, in the present embodiment, the streaming service system 100 includes a plurality of switch nodes 110-1 to 110-4, a plurality of surrogate servers 120-1 to 120-2, a content management apparatus 130 and a controller 140. The switch nodes 110-1 to 110-4 are connected together, and the surrogate servers 120-1 to 120-2 are respectively connected to the switch nodes 110-1 and 110-3. The controller 140 is connected to the switch nodes 110-1 to 110-4, and communicates with the content management apparatus 130. Specifically, the controller 140 is, for example, directly connected to the content management apparatus 130 for communication. Or, the controller 140, for example, communicates with the content management apparatus 130 through the switch nodes 110-1 to 110-4. Further, the controller 140, for example, communicates with the content management apparatus 130 through the Internet. In an embodiment of the disclosure, the streaming service system 100 may further include a router 150 configured to connect another surrogate server 120-3.

The streaming service system 100 belongs to a software-defined network (SDN) structure. Generally, the SDN structure includes a control plane and a data plane. In the streaming service system 100, the control plane refers to the part that the controller 140 performs control, management and information exchange on the switch nodes 110-1 to 110-4 and the content management apparatus 130, and the data plane refers to the part that the switch nodes 110-1 to 110-4 and the content management apparatus 130 transmit packets according to instructions of the control plane.

In the present embodiment, the switch nodes 110-1 to 110-4 are, for example, network switches having a plurality of transmission ports to assist transmitting packets in the streaming service system 100, though the disclosure is not limited thereto. The content management apparatus 130 is, for example, an electronic apparatus such as a computer or a server, which is used for managing data and information in the streaming service system 100. In the present embodiment, the content management apparatus 130 is used for managing video and audio data in the streaming service system 100. To be specific, the content management apparatus 130, for example, records the surrogates 120-1 and 120-2 where each batch of video and audio data is located, and organizes the video and audio data that can be provided by the streaming service system 100 into a video and audio content list.

The controller 140 includes a communication interface 142, a storage unit 144 and a processor 146. The content management apparatus 130 and the switch nodes 110-1 to 110-4 are connected to the communication interface 142, and the processor 146 is coupled to the communication interface 142 and the storage unit 144. The controller 140 is, for example, an electronic device such as a computer or a server. To be specific, the communication interface 142 supports various wired and wireless communication standards, for example, an Ethernet interface, a bluetooth communication standard, a ZIGBEE communication standard, a Wi-Fi communication standard, a long term evolution (LTE) communication standard, etc., though the disclosure is not limited thereto. The storage unit 144 is, for example, a storage device such as a hard disk, a random access memory (RAM), etc.

The processor 146 can be any type of a control circuit, for example, a system-on-chip (SOC), an application processor, a media processor, a microprocessor, a central processing unit (CPU), a digital signal processor or other similar device.

A client apparatus 160-1 is joined to the streaming service system 100 by connecting the switch node 110-2, and a user of the client apparatus 160-1 may use the client apparatus 160-1 to select desired video and audio data from the streaming service system 100 for watching. To be specific, in the present embodiment, when the client apparatus 160-1 is joined to the streaming service system 100, the content management apparatus 130, for example, presents the video and audio data that can be provided by the streaming service system 100 on the client apparatus 160-1 in form of a webpage. When the user selects the video and audio data to be viewed, the streaming service system 100 further adds the client apparatus 160-1 to a streaming group of the video and audio data based on the selected video and audio data, so as to provide streaming packets of the video and audio data to the client apparatus 160-1 by using a corresponding multicast tree.

Regarding the embodiment of FIG. 1, when the client apparatus 160-1 (i.e. a first client apparatus) is joined to the streaming group, the content management apparatus 130 informs the controller 140, and the processor 146 of the controller 140 selects one surrogate server (i.e. a first surrogate server, for example, the surrogate server 120-1) from the surrogate servers capable of providing the corresponding video and audio data, and sets a portion of the switch nodes (for example, the switch nodes 110-1 and 110-2) to adjust the multicast tree, such that the selected surrogate server 120-1 transmits streaming packets to the client apparatus 160-1 through a transmission route (i.e. a first transmission route including the switch nodes 110-1 and 110-2) of the multicast tree. The processor 146 of the controller 140, for example, modifies flow tables in the switch nodes 110-1 and 110-2 to adjust the multicast tree, so as to form the transmission route between the surrogate server 120-1 and the client apparatus 160-1. However, the streaming service system provided by the disclosure is not limited to the embodiment shown in FIG. 1.

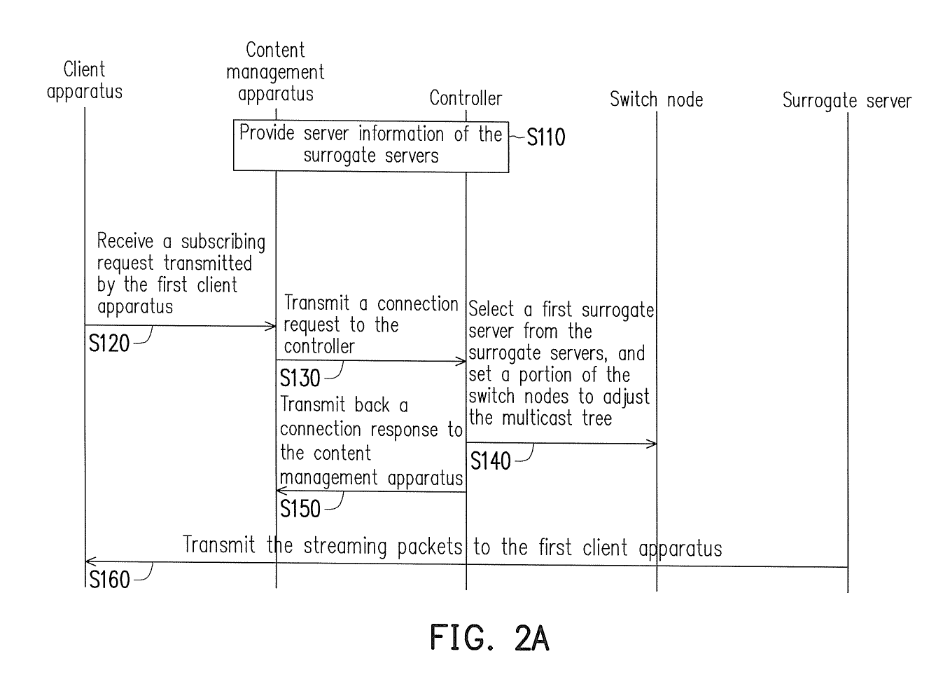

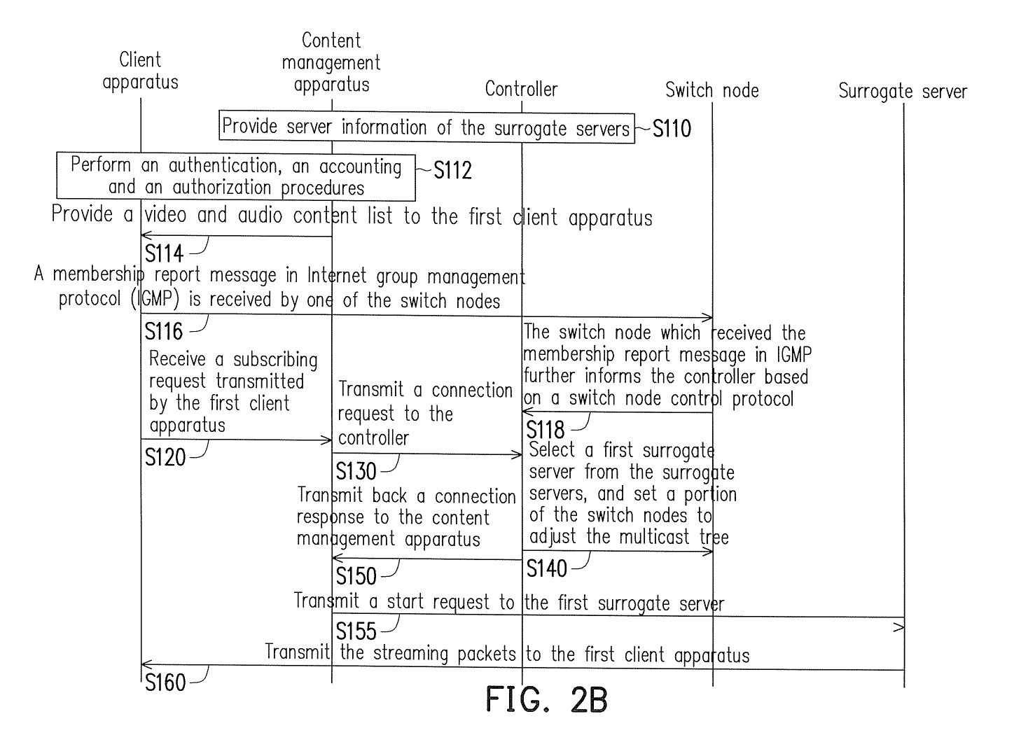

FIG. 2A is a flowchart illustrating a streaming service method according to an embodiment of the disclosure. Referring to FIG. 2A, the streaming service method is adapted to the streaming service system 100 of FIG. 1, though the disclosure is not limited thereto. Referring to FIG. 2A, in the streaming service method, the content management apparatus 130 provides server information of the surrogate servers 120-1 to 120-2 to the controller 140 (step S110). To be specific, the server information, for example, includes identification codes and network addresses of each of the surrogate servers 120-1 to 120-2 and information of the streaming groups corresponding to the video and audio data stored in each of the surrogate servers 120-1 to 120-2. The controller 140 stores the server info' nation in the storage unit 144.

Then, during a process of adding the client apparatus 160-1 to the streaming group, the content management apparatus 130 receives a subscribing request transmitted by the client apparatus 160-1 (step S120), and the content management apparatus 130 transmits a connection request to the controller 140 after receiving the subscribing request (step S130). To be specific, the subscribing request sent by the client apparatus 160-1, for example, includes content information of the selected video and audio data and an identification code of the client apparatus 160-1, etc. After receiving the subscribing request, the content management apparatus 130 further generates the connection request and transmits the connection request to the controller 140. The connection request includes the content information of the selected video and audio data, the identification code of the client apparatus 160-1, a bandwidth requirement for transmitting the streaming packets of the video and audio data, etc., and the controller 140 stores the connection request to the storage unit 144.

After receiving the connection request, the processor 146 of the controller 140 selects one of the surrogate servers 120-1 and 120-2 capable of providing the corresponding video and audio data (i.e. the first surrogate server, for example, the surrogate server 120-1), and sets a portion of the switch nodes (for example, the switch nodes 110-1 and 110-2) to adjust the multicast tree (step S140). After adjusting the multicast tree, the controller 140 further transmits back a connection response to the content management apparatus 130 (step S150). The connection response includes the identification code of the client apparatus 160-1, an identification code of the surrogate server 120-1 used for providing the streaming packets, etc.

Finally, the surrogate server 120-1 selected by the controller 140 transmits the streaming packets to the client apparatus 160-1 through a transmission route (i.e. the first transmission route including the switch nodes 110-1 and 110-2) of the adjusted multicast tree (step S160).

FIG. 2B is a flowchart illustrating a streaming service method according to another embodiment of the disclosure. Referring to FIG. 2B, the streaming service method is adapted to the streaming service system 100 of FIG. 1, though the disclosure is not limited thereto. To be specific, in the streaming service method shown in FIG. 2B, when the client apparatus 160-1 is joined to the streaming service system 100, an authentication, an accounting and an authorization procedures are first performed between the client apparatus 160-1 and the content management apparatus 130 (step S112). Then, the content management apparatus 130 provides a video and audio content list to the client apparatus 160-1 (step S114). The user of the client apparatus 160-1 may select the video and audio data to be viewed according to the video and audio content list.

On the other hand, during a process of adding the client apparatus 160-1 to the streaming group, if the streaming service system 100 respectively manages group members in the multicast tree of the streaming packets based on an Internet group management protocol (IGMP), when the client apparatus 160-1 is added to the streaming group, the client apparatus 160-1 further transmits a membership report message in IGMP, and the membership report message is received by one of the switch nodes 110-1 to 110-4 (step S116). The switch node which received the membership report message further informs the controller 140 based on a switch node control protocol, such as an Openflow protocol (step S118). An execution sequence of the steps S116, S118 and the steps S120, S130 is not limited to the embodiment of FIG. 2B.

Referring to FIG. 2B, after receiving the connection response, the content management apparatus 130 further transmits a start request to the surrogate server 120-1 selected in the step S140 (step S155). To be specific, if the client apparatus 160-1 is the first client apparatus of the joined streaming group, the content management apparatus 130 transmits the start request to the surrogate server 120-1. After receiving the start request, the surrogate server 120-1 transmits the streaming packets to the client apparatus 160-1 through the transmission route (including the switch nodes 110-1 and 110-2) of the multicast tree.

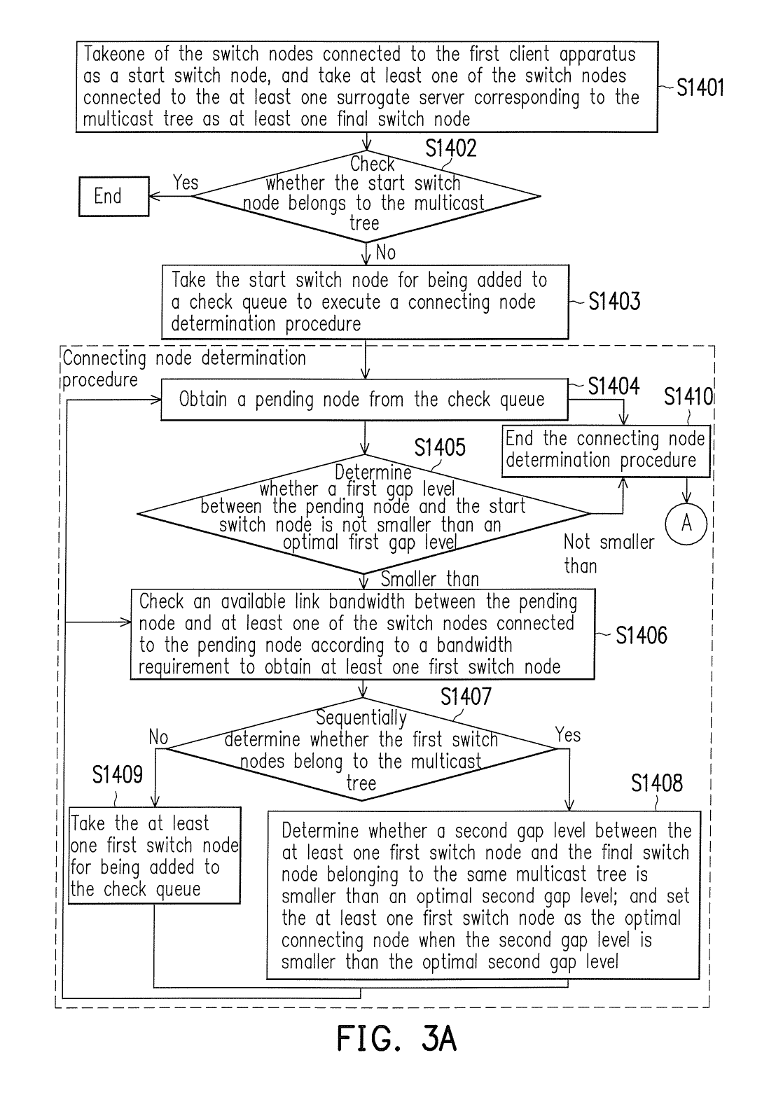

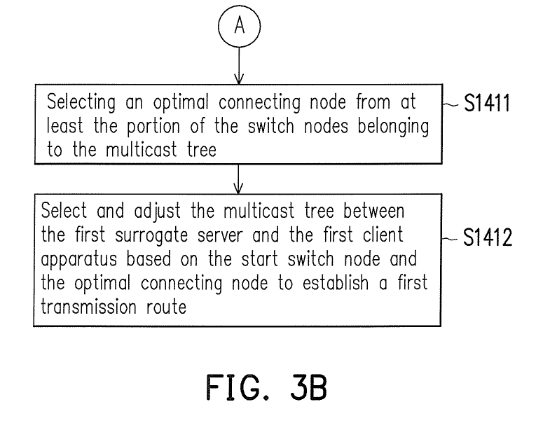

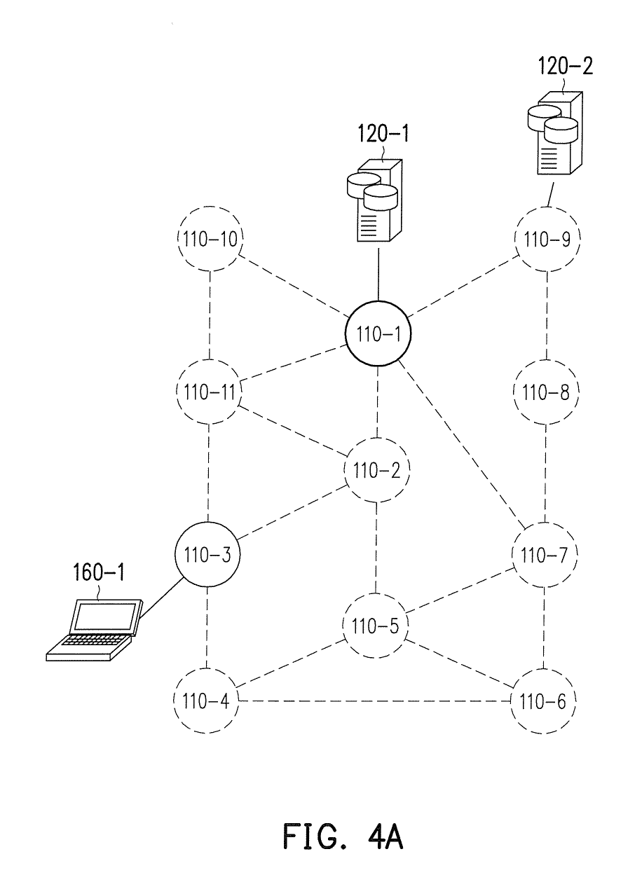

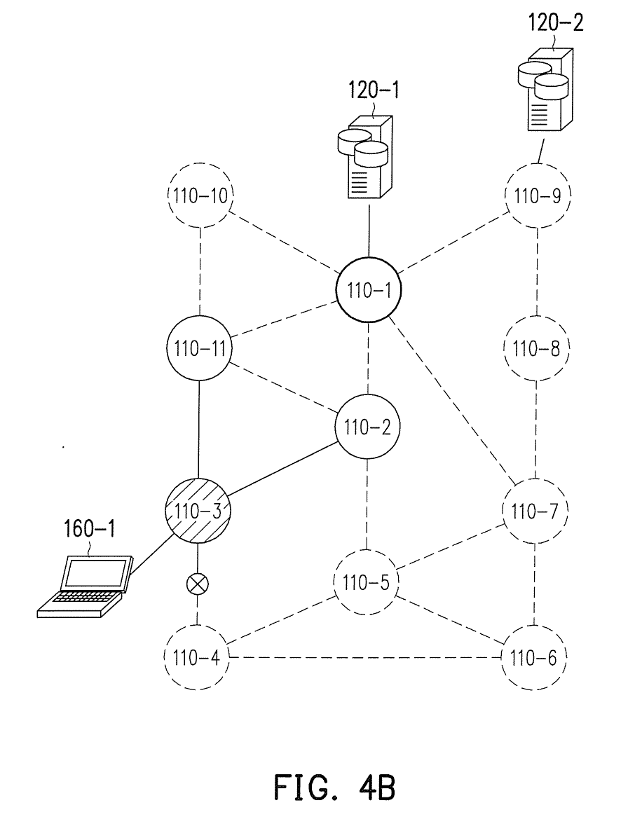

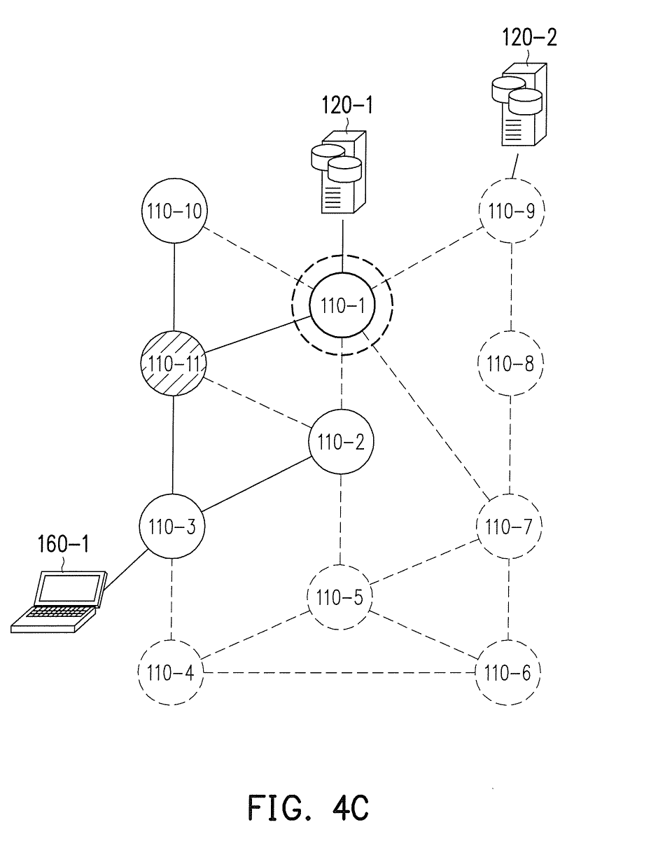

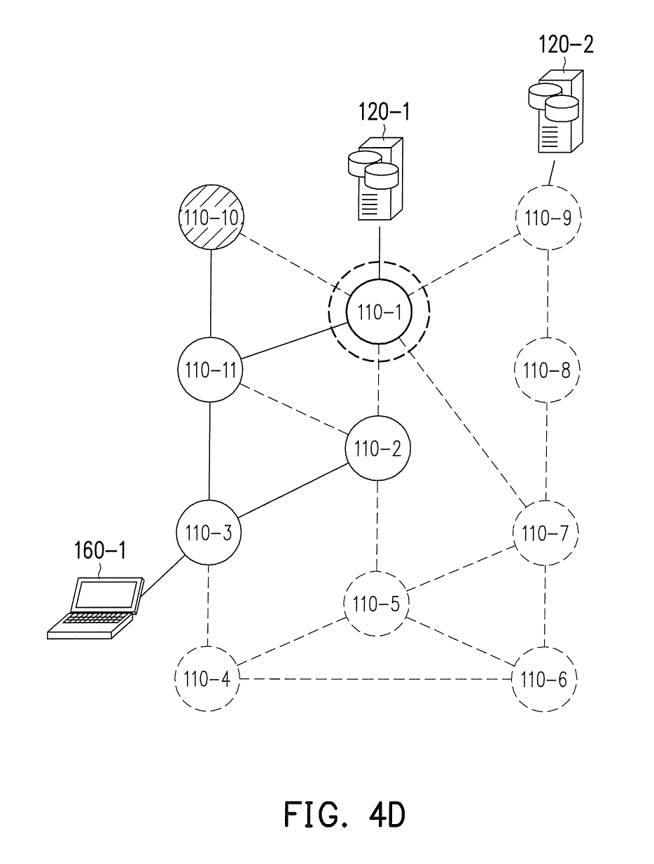

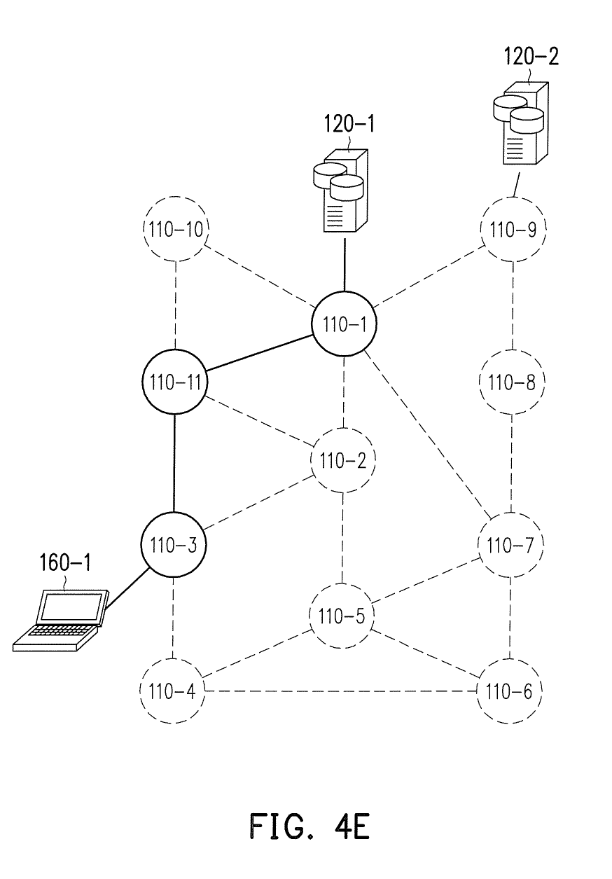

FIGS. 3A-3B are flowcharts illustrating method for selecting the first surrogate server and adjusting the multicast tree according to an embodiment of the disclosure. FIGS. 4A-4E are schematic diagrams of selecting the first surrogate server and adjusting the multicast tree according to an embodiment of the disclosure. To be specific, FIGS. 4A-4E are schematic diagram illustrating a process that the controller 140 selects the first surrogate server and adjusts the multicast tree when the client apparatus 160-1 is joined to the streaming module as the first one client apparatus. The switch nodes 110-1 to 110-11, the surrogate servers 120-1 to 120-2 and the client apparatus 160-1 shown in FIGS. 4A-4E are different to an overall structure of the streaming service system 100 shown in FIG. 1.

Referring to FIGS. 3A-3B and FIG. 4A, after receiving the connection request, the processor 146 of the controller 140 first takes the switch node 110-3 connected to the client apparatus 160-1 (i.e. the first client apparatus) as a start switch node, and takes the switch nodes 110-1 and 110-9 connected to the surrogate servers 120-1 and 120-2 corresponding to the multicast tree as final switch nodes (step S1401). In the present embodiment, the surrogate servers 120-1 and 120-2 corresponding to the multicast tree may all provide the streaming packets of the video and audio data required by the client apparatus 160-1, and the final switch nodes 110-1 and 110-9 and the surrogate servers 120-1 and 120-2 respectively connected thereto all belong to the same multicast tree.

Then, the processor 146 of the controller 140 checks whether the start switch node 110-3 belongs to the multicast tree (step S1402). If the start switch node 110-3 belongs to the multicast tree, the client apparatus 160-1 connected to the start switch node 110-3 may directly receive the streaming packets of the selected video and audio data from the start switch node 110-3, so that the controller 140 is only required to set the start switch node 110-3 to adjust the multicast tree.

However, if the start switch node 110-3 does not belong to the multicast tree, the processor 146 of the controller 140 takes the start switch node 110-3 as a pending node for being added to a check queue to execute a connecting node determination procedure (step S1403). To be specific, referring to FIGS. 3A-3B and FIG. 4B, in the connecting node determination procedure, the processor 146 of the controller 140 obtains the pending node from the check queue (step S1404), and now the pending node is the start switch node 110-3.

After obtaining the pending node 110-3, the processor 146 of the controller 140 determines whether a first gap level between the pending node 110-3 and the start switch node 110-3 is not smaller than an optimal first gap level (step S1405). Here, since the pending node and the start switch node are all the switch node 110-3, the first gap level is 1. On the other hand, the optimal first gap level is now a default value, for example, infinite. Therefore, the first gap level between the pending node 110-3 and the start switch node 110-3 is smaller than the optimal first gap level.

Referring to FIG. 4B again, if the first gap level is smaller than the optimal first gap level, the processor 146 of the controller 140 checks an available link bandwidth between the pending node 110-3 and the switch nodes 110-11, 110-2 and 110-4 connected thereto according to a bandwidth requirement in transmission of the streaming packets to obtain first switch nodes 110-11 and 110-2 (step S1406). To be specific, when the available link bandwidth between the pending node 110-3 and the switch nodes 110-11 and 110-2 connected thereto is greater than the aforementioned bandwidth requirement, the switch nodes 110-11 and 110-2 are sequentially the first switch nodes 110-11 and 110-2. Conversely, the switch node (for example, the switch node 110-4) does not serve as the first switch node.

After obtaining the first switch nodes 110-11 and 110-2, the processor 146 of the controller 140 sequentially determines whether the first switch nodes 110-11 and 110-2 belong to the multicast tree (step S1407). Referring to FIG. 4B again, the processor 146 of the controller 140 first determines whether the first switch node 110-11 belongs to the multicast tree. Since the first switch node 110-11 does not belong to the multicast tree, the processor 146 of the controller 140 takes the first switch node 110-11 as the pending node for being added to the check queue (step S1409). Similarly, the processor 146 of the controller 140 also takes the first switch node 110-2 as the pending node for being added to the check queue.

Referring to FIGS. 3A-3B and FIG. 4C, after the controller 140 determines that the first switch nodes 110-11 and 110-2 do not belong to the multicast tree, and takes the same nodes 110-11 and 110-2 for being added to the check queue, the processor 146 of the controller 140 re-obtains the pending node 110-11 from the check queue (step S1404). Then, the processor 146 of the controller 140 determines whether a first gap level between the pending node 110-11 and the start switch node 110-3 is not smaller than the optimal first gap series (step S1405). Here, the first gap level between the pending node 110-11 and the start switch node 110-3 is 2, and the optimal first gap level is still the default value.

Referring to FIGS. 3A-3B and FIG. 4C, since the first gap level is smaller than the optimal first gap level, the processor 146 of the controller 140 checks an available link bandwidth between the pending node 110-11 and the switch nodes 110-10 and 110-1 connected thereto according to a bandwidth requirement in transmission of the streaming packets to obtain the first switch nodes 110-10 and 110-1 (step S1406). After obtaining the first switch nodes 110-1 and 110-10, the processor 146 of the controller 140 sequentially determines whether the first switch nodes 110-1 and 110-10 belong to the multicast tree (step S1407).

Since the first switch node 110-1 is the final switch node 110-1 belonging to the multicast tree, the processor 146 of the controller 140 determines whether a second gap level between the first switch node 110-1 and the final switch node 110-1 belonging to the same multicast tree is smaller than an optimal second gap level, and when the second gap level is smaller than the optimal second gap level, the processor 146 of the controller 140 sets the first switch node 110-1 as an optimal connecting node (step S1408). In detail, in FIG. 4C, the first switch node and the final switch node are all the switch node 110-1, so that the second gap level between the first switch node 110-1 and the final switch node 110-1 is 1. On the other hand, the optimal second gap level is now the aforementioned default value, and the default value is, for example, infinite. Now, the controller 140 sets the first switch node 110-1 as the optimal connecting node.

On the other hand, since the first switch node 110-10 does not belong to the multicast tree, the processor 146 of the controller 140 takes the first switch node 110-10 as the pending node for being added to the check queue (step S1409).

In the present embodiment, the optimal first gap level is defined as the first gap level between the optimal connecting node and the start switch node, and the optimal second gap level is defined as the second gap level between the optimal connecting node and the final switch node belong to the same multicast tree. In the embodiment of FIGS. 4A-4C, before the controller 140 sets the first switch node 110-1 as the optimal connecting node, the optimal connecting node is a null value or a null set. At that time, the optimal first gap level and the optimal second gap level are all the default value, and the default value is, for example, infinite. In other words, before executing the connecting node determination procedure, the processor 146 of the controller 140 respectively sets the optimal first gap level and the optimal second gap level to the default value.

Referring to FIGS. 3A-3B and FIG. 4D, the processor 146 of the controller 140 obtains the pending node 110-2 from the check queue (step S1404). Then, through the steps S1405-S1409, the processor 146 of the controller 140 takes the first switch node 110-5 as the pending node for being added to the check queue. On the other hand, since the switch nodes 110-11, 110-2 belong to a same level relative to the switch node 110-3, i.e. the gap level between respectively the switch nodes 110-11, 110-2 and the switch node 110-3 are all 2, the processor 146 of the controller 140 does not again sets the final switch node 110-1 as the optimal connecting node. Then, the processor 146 of the controller 140 obtains the pending node 110-10 from the check queue (step S1404). Since the first gap level between the pending node 110-10 and the start switch node 110-3 is 3, and is not smaller than the optimal first gap level of 3 between the optimal connecting node 110-1 and the start switch node 110-3 (step S1405), the processor 146 of the controller 140 ends the connecting node determination procedure (step S1410).

In the connecting node determination procedure, once the check queue does not have the waiting pending node, the processor 146 of the controller 140 also ends the connecting node determination procedure (step S1410).

Referring to FIGS. 3A-3B and FIG. 4E, after the connecting node determination procedure is executed, the processor 146 of the controller 140 selects an optimal connecting node from the switch nodes belonging to the multicast tree (step S1411). In the present embodiment, the optimal connecting node is the switch node 110-1. Then, the processor 146 of the controller 140 selects and adjusts the multicast tree between the first surrogate server and the client apparatus 160-1 based on the start switch node 110-3 and the optimal connecting node 110-1 to establish a first transmission route (step S1412). According to the embodiment shown in FIG. 4A-4E, the processor 146 of the controller 140 selects the surrogate server 120-1 that belongs to the same multicast tree with the optimal connecting node 110-1 as the aforementioned first surrogate server, and adjusts the multicast tree between the surrogate server 120-1 and the client apparatus 160-1 to establish the transmission route (i.e. the first transmission route). To be specific, the aforementioned transmission route includes the switch nodes 110-3, 110-1 and 110-11, and the multicast tree where the aforementioned switch nodes 110-3, 110-1 and 110-11 belong to corresponds to the streaming packets provided by the surrogate server 120-1.

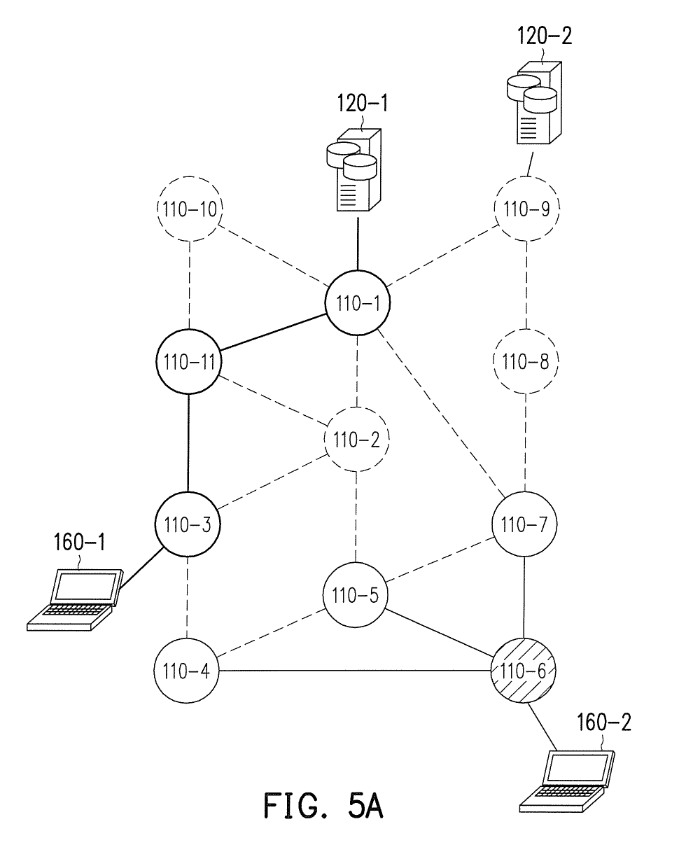

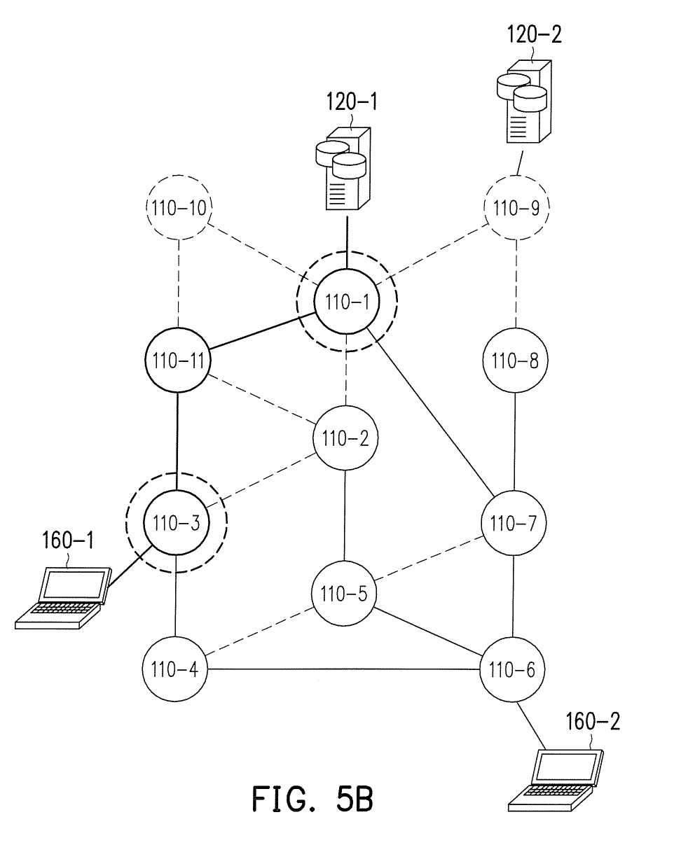

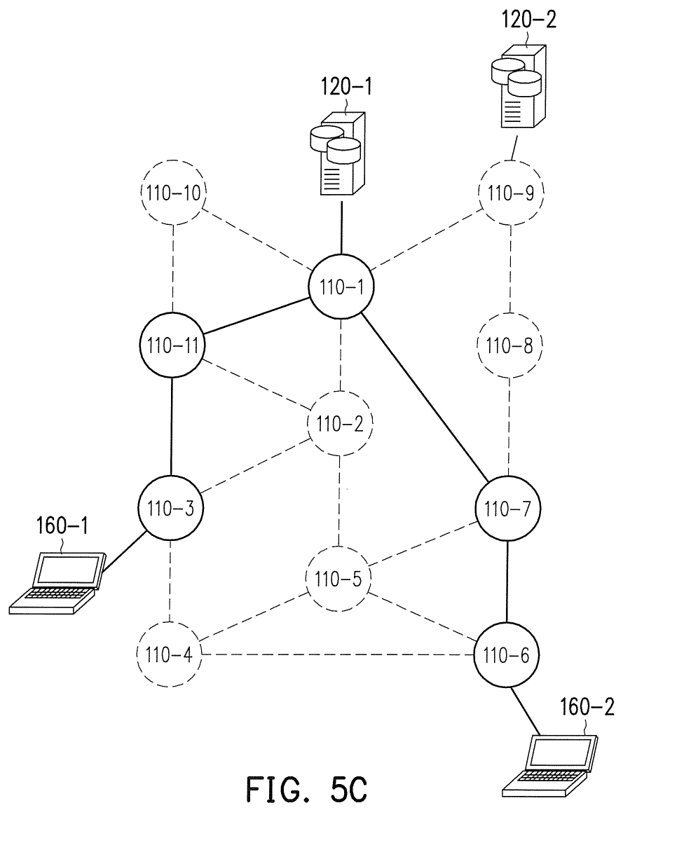

FIGS. 5A-5C are schematic diagrams of selecting the first surrogate server and adjusting the multicast tree according to an embodiment of the disclosure. To be specific, FIGS. 5A-5C are schematic diagram illustrating a process that the controller 140 selects the first surrogate server and adjusts the multicast tree when a client apparatus 160-2 is joined to the streaming group. Different to the embodiment of FIGS. 4A-4E, in the embodiment of FIGS. 5A-5C, the streaming group already has a group member (i.e. the client apparatus 160-1), and the client apparatus 160-1 and the surrogate server 120-1 already have a multicast tree therebetween, and the multicast tree includes the switch nodes 110-3, 110-1 and 110-11.

Referring to FIGS. 3A-3B and FIG. 5A, the switch node 110-6 connected to the client apparatus 160-2 serves as the start switch node, and after the processor 146 of the controller 140 sequentially executes the steps S1401-S1409, pending nodes 110-4, 110-5 and 110-7 are sequentially obtained. Then, referring to FIGS. 3A-3B and FIG. 5B, first taking the pending node 110-4 as an object, after the processor 146 of the controller 140 executes the steps S1404-S1409, the optimal connecting node 110-3 is obtained. Now, the optimal first gap level between the optimal connecting node 110-3 and the start switch node 110-6 is 3, and the optimal second gap level between the optimal connecting node 110-3 and the final switch node 110-1 belonging to the same multicast tree is also 3.

Then, referring to FIGS. 3A-3B and FIG. 5B again, and taking the pending node 110-7 as an object, after the processor 146 of the controller 140 executes the steps S1404-S1409, the first switch node 110-1 is obtained. Since the first switch node 110-1 also belongs to the multicast tree, and the second gap level between the first switch node 110-1 and the final switch node 110-1 is only 1, the second gap level between the first switch node 110-1 and the final switch node 110-1 is smaller than the optimal second gap level between the optimal connecting node 110-3 and the final switch node 110-1, and the processor 146 of the controller 140 changes to set the first switch node 110-1 as the optimal connecting node.

Finally, as shown in FIG. 5C, the processor 146 of the controller 140 selects and adjusts the multicast tree between the first surrogate server and the client apparatus 160-2 based on the start switch node 110-6 and the optimal connecting node 110-1 to establish the transmission route. In the embodiment of FIG. 5C, the surrogate server 120-1 is the aforementioned first surrogate server, and the transmission route (the first transmission route) between the surrogate server 120-1 and the client apparatus 160-2 includes the switch nodes 110-6, 110-1 and 110-7.

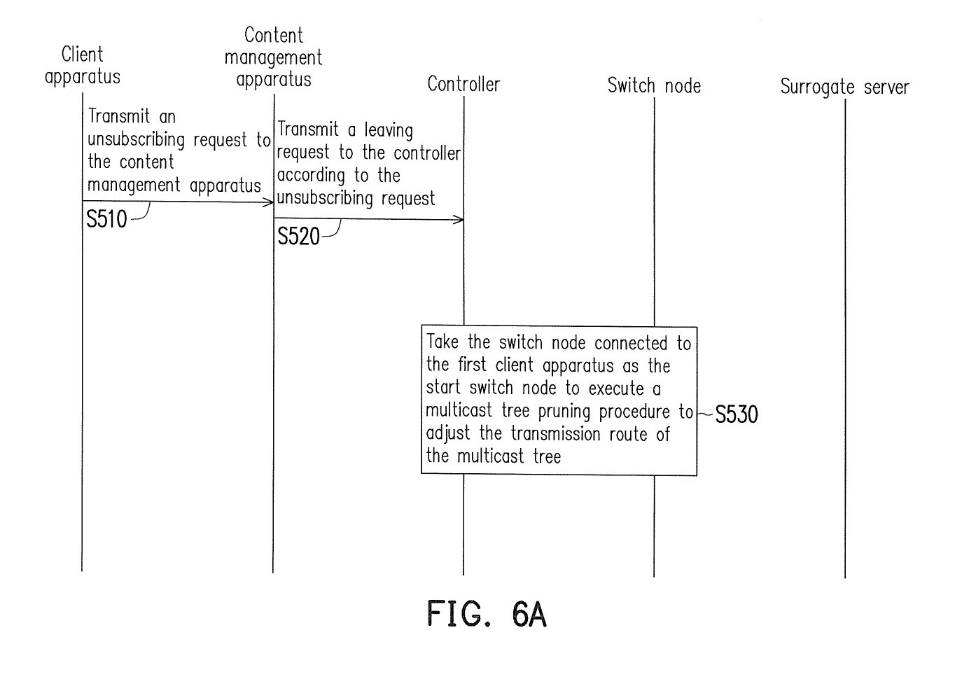

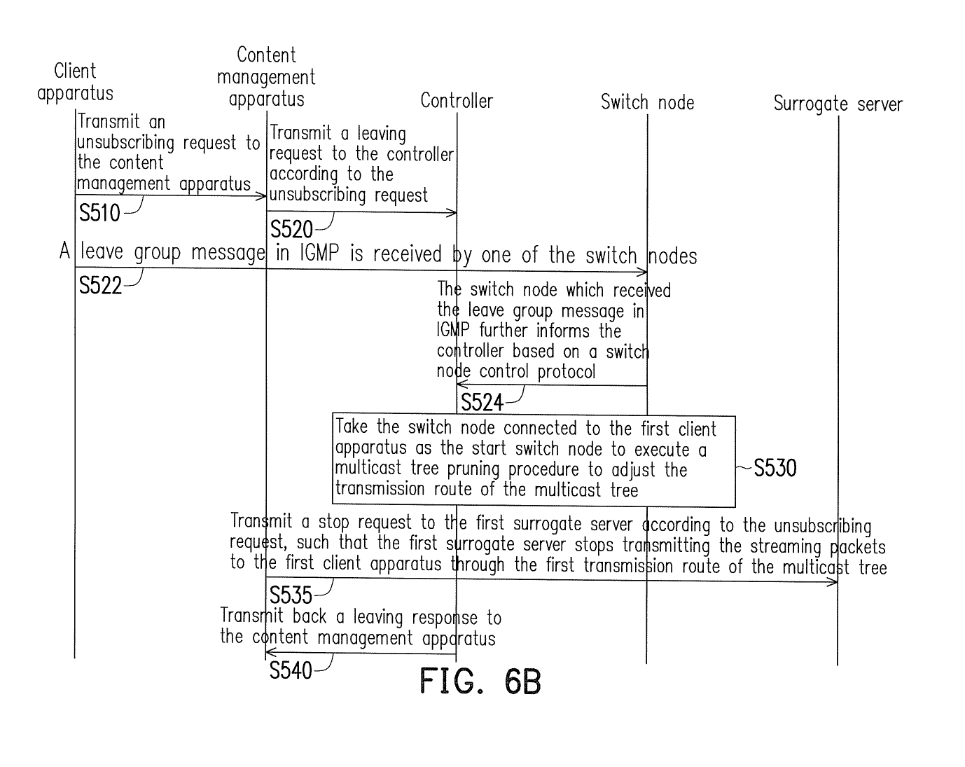

FIG. 6A is a flowchart illustrating a streaming service method according to still another embodiment of the disclosure. Referring to FIG. 6A, in the present embodiment, when the client apparatus (i.e. the first client apparatus, for example, the client apparatus 160-1 shown in FIG. 1) leaves the streaming group, the content management apparatus 130 informs the controller 140, and the processor 146 of the controller 140 sets at least a portion of the switch nodes (for example, the switch nodes 110-1 and 110-2 of FIG. 1) to adjust the multicast tree.

Referring to FIG. 6A and FIG. 1, during the process that the client apparatus 160-1 leaves the streaming group, the client apparatus 160-1 first transmits an unsubscribing request to the content management apparatus 130 (step S510). After the content management apparatus 130 receives the unsubscribing request, the content management apparatus 130 transmits a leaving request to the controller 140 according to the unsubscribing request (step S520). Both of the unsubscribing request and the leaving request include content information of the currently received video and audio data, the identification code of the client apparatus 160-1 and etc. After the controller 140 receives the leaving request, the processor 146 of the controller 140 takes the switch node 110-2 connected to the client apparatus 160-1 as the start switch node to execute a multicast tree pruning procedure to adjust the transmission route (i.e. the first transmission route including the switch nodes 110-1 and 110-2 of FIG. 1) of the multicast tree (step S530).

FIG. 6B is a flowchart illustrating a streaming service method according to still another embodiment of the disclosure. A difference between the present embodiment and the embodiment of FIG. 6A is that in the embodiment of FIG. 6B, when the client apparatus 160-1 transmitting the unsubscribing request is the last client apparatus in the streaming group, the content management apparatus 130 further transmits a stop request to the surrogate server 120-1 according to the unsubscribing request, such that the surrogate server 120-1 stops transmitting the streaming packets to the client apparatus 160-1 through the transmission route (including the switch nodes 110-1 and 110-2 of FIG. 1) of the multicast tree (step S535). To be specific, the surrogate server 120-1 stops transmitting the streaming packets.

On the other hand, referring to FIG. 6B, during the process that the client apparatus 160-1 leaves the streaming group, the client apparatus 160-1 further transmits a leave group message in IGMP to the streaming service system 100, and the leave group message in IGMP is received by one of the switch nodes 110-1 to 110-4 (step S522). Moreover, the switch node which received the leave group message in IGMP (for example, the switch node 110-1) belonging to the same multicast tree with the client apparatus 160-1 further informs the controller 140 based on the switch node control protocol, such as the Openflow protocol (step S524). An execution sequence of the steps S522, S524 and the steps S510, S520 is not limited to the embodiment of FIG. 6B.

Moreover, in the embodiment of FIG. 6B, after executing the multicast tree pruning procedure, the processor 146 of the controller 140 further transmits back a leaving response to the content management apparatus 130 (step S540). The leaving response includes the identification code of the client apparatus 160-1, etc.

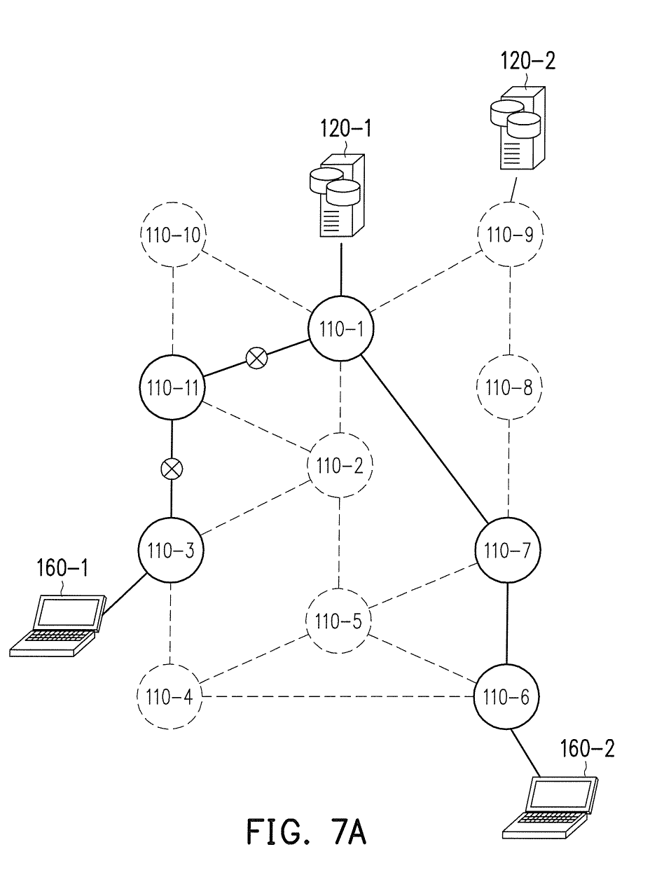

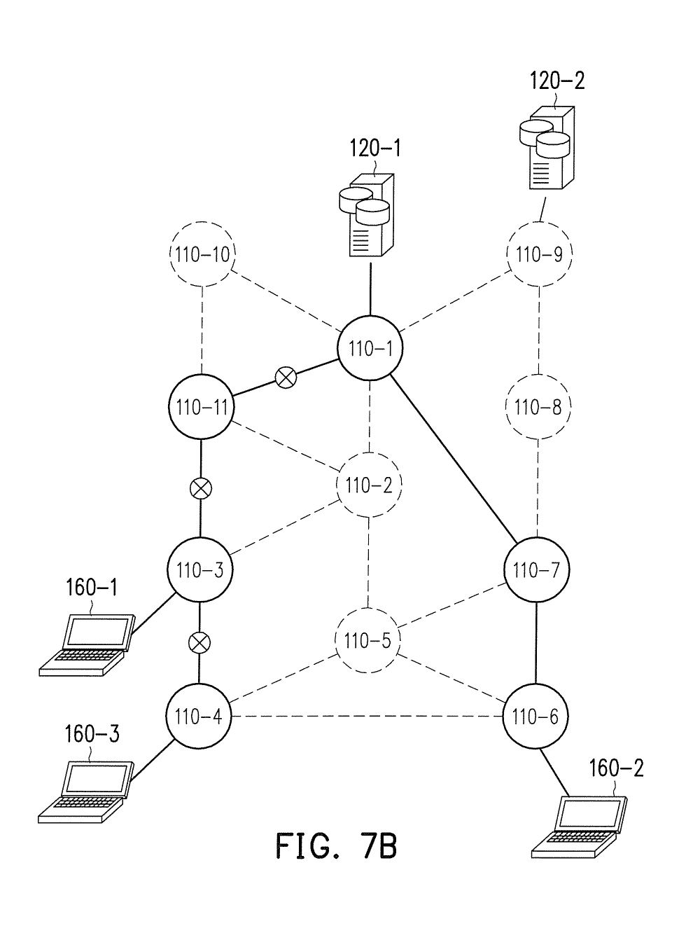

FIG. 7A and FIG. 7B are schematic diagrams of the multicast tree pruning procedure according to an embodiment of the disclosure. It should be noted that the switch nodes 110-1 to 110-11, the surrogate servers 120-1 to 120-2 and the client apparatus 160-1 shown in FIGS. 7A and 7B are different to the overall structure of the streaming service system 100 of FIG. 1. Referring to FIGS. 7A and 7B, in the multicast tree pruning procedure, when the client apparatus 160-1 (i.e. the first client apparatus) wants to leave the streaming group, the processor 146 of the controller 140 determines whether the start switch node 110-3 connected to the client apparatus 160-1 is applied to the second transmission route of the multicast tree. Generally, the surrogate server 120-1 (i.e. the first surrogate server) transmits the streaming packets to another client apparatus (i.e. the second client apparatus, for example, the client apparatus 160-3 shown in FIG. 7B) through the second transmission route of the multicast tree. In FIG. 7B, the second transmission route is a transmission route between the client apparatus 160-3 and the surrogate server 120-1, and the second transmission route includes the switch nodes 110-1, 110-11, 110-3 and 110-4.

Referring to the embodiment of FIG. 7A, when the start switch node 110-3 connected to the client apparatus 160-1 is not applied to the other transmission route of the multicast tree, the processor 146 of the controller 140 excludes the switch nodes 110-3 and 110-11 that are only applied to the transmission route between the client apparatus 160-1 and the surrogate server 120-1 (i.e. the first transmission route) in the multicast tree from the multicast tree.

Referring to the embodiment of FIG. 7B, when the start switch node 110-3 connected to the client apparatus 160-1 is applied to the transmission route between the client apparatus 160-3 and the surrogate server 120-1 (i.e. the second transmission route) in the multicast tree, the controller 140 excludes the switch nodes 110-3 and 110-11 in the transmission route between the client apparatus 160-1 and the surrogate server 120-1 (i.e. the first transmission route) that are located in an upstream of the start switch node 110-3 and not applied to other branch routes of the multicast tree from the multicast tree. The controller 140 further reconnects a downstream switch node 110-4 connected to the start switch node 110-3 in the second transmission route to the multicast tree to adjust the transmission route between the client apparatus 160-3 and the surrogate server 120-1. To be specific, the switch node 110-4 is, for example, reconnected to the switch node 110-1, 110-7 or 110-6. The method flow shown in FIGS. 3A-3B can be applied to assist re-adding the switch node 110-4 to the multicast tree of the surrogate server 120-1. To be specific, the switch node 110-4 is, for example, taken as the pending node for being added to the check queue, and the steps S1404-S1412 are re-executed.

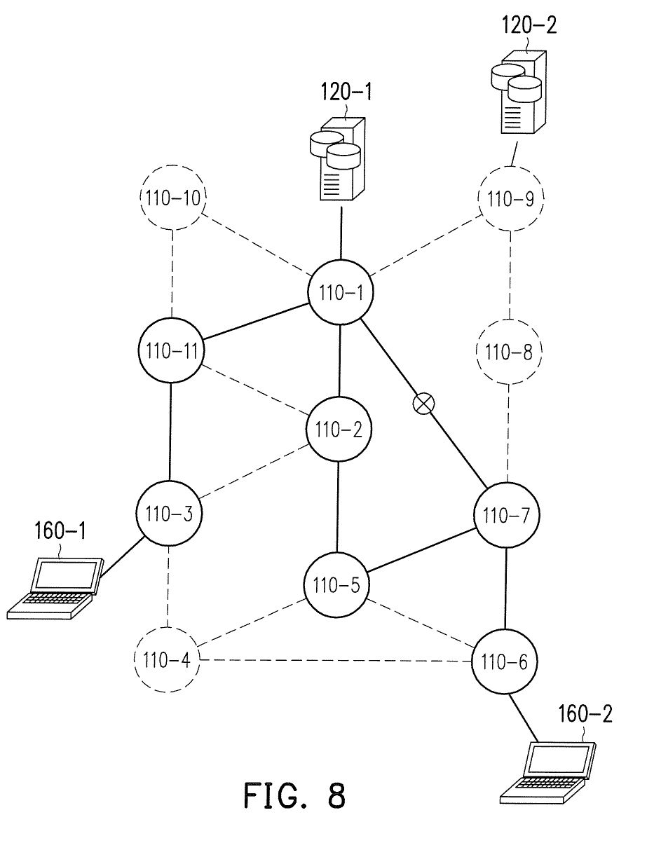

FIG. 8 is a schematic diagram of determining a link congestion to adjust a transmission route according to an embodiment of the disclosure. Referring to FIG. 8, in the embodiment of FIG. 8, the multicast tree includes switch nodes 110-1, 110-11, 110-3, 110-7 and 110-6. In the present embodiment, the processor 146 of the controller 140 further selectively polls the switch nodes 110-1, 110-11, 110-3, 110-7 and 110-6 of the multicast tree to determine whether the transmission route has a link congestion. To be specific, the processor 146 of the controller 140 may poll the switch nodes 110-1, 110-11 and 110-3 to determine whether the transmission route between the client apparatus 160-1 and the surrogate server 120-1 (i.e. the first transmission route) has the link congestion. On the other hand, the processor 146 of the controller 140 may poll the switch nodes 110-1, 110-7 and 110-6 to determine whether the transmission route between the client apparatus 160-2 and the surrogate server 120-1 has the link congestion.

When the link congestion occurs in the transmission route between the client apparatus 160-1 and the surrogate server 120-1, or the link congestion is occurred in the transmission route between the client apparatus 160-2 and the surrogate server 120-1, the processor 146 of the controller 140 adjusts the transmission route of the multicast tree by setting a portion of the switch nodes. To be specific, when the switch nodes 110-7 and 110-1 have the link congestion, the processor 146 of the controller 140 adjusts the transmission path between the client apparatus 160-2 and the surrogate server 120-1 by setting the switch nodes 110-1, 110-2, 110-5 and 110-7, so as to maintain the transmission quality of the streaming packets.

In summary, in the streaming service system, the streaming service method and the controller provided by the embodiments of the disclosure, when the client apparatus is joined to the streaming group, the controller adjusts the multicast tree, such that the streaming packets can be transmitted between the client apparatus and the surrogate server through the transmission route of the multicast tree. Moreover, when the client apparatus leaves the streaming group or in the case of link congestion, the controller further adjusts the multicast tree to cancel or adjust the transmission route between the client apparatus and the surrogate server. With assistance of the controller, transmission of video audio streaming may satisfy a requirement of basic bandwidth. On the other hand, the transmission route between the client apparatus and the surrogate server may cope with a demand of the shortest route.

It will be apparent to those skilled in the art that various modifications and variations can be made to the structure of the disclosure without departing from the scope or spirit of the disclosure. In view of the foregoing, it is intended that the disclosure cover modifications and variations of this disclosure provided they fall within the scope of the following claims and their equivalents.

What is claimed is:

1. A streaming service system, comprising:
a plurality of switch nodes, the switch nodes are connected;
a plurality of surrogate servers, respectively connected to one of the switch nodes;
a content management apparatus; and
a controller, connected to the switch nodes, and communicates with the content management apparatus,
wherein the content management apparatus provides server information of the surrogate servers to the controller,
wherein when a first client apparatus is joined to a streaming group, the content management apparatus informs the controller, and the controller selects a first surrogate server from the surrogate servers, and sets at least a portion of the switch nodes to adjust a multicast tree,
the first surrogate server transmits streaming packets to the first client apparatus through a first transmission route of the multicast tree.

2. The streaming service system as claimed in claim 1, wherein when the first client apparatus is joined to the streaming group, the first client apparatus transmits a subscribing request to the content management apparatus, and the content management apparatus transmits a connection request to the controller according to the subscribing request,
after the controller receives the connection request, the controller selects the first surrogate server corresponding to the streaming group, and sets at least the portion of the switch nodes to adjust the multicast tree, and transmits back a connection response to the content management apparatus.

3. The streaming service system as claimed in claim 2, wherein after the content management apparatus receives the connection response, the content management apparatus further transmits a start request to the first surrogate server, the first surrogate server receives the start request, and transmits the streaming packets to the first client apparatus through the first transmission route of the multicast tree.

4. The streaming service system as claimed in claim 2, wherein the controller takes one of the switch nodes connected to the first client apparatus as a start switch node, and takes at least one of the switch nodes connected to the at least one surrogate server corresponding to the multicast tree as at least one final switch node, wherein the at least one final switch node belongs to the multicast tree, and the controller checks whether the start switch node belongs to the multicast tree,
if the start switch node does not belong to the multicast tree, the controller takes the start switch node for being added to a check queue to execute a connecting node determination procedure,
the controller executes the connecting node determination procedure to select an optimal connecting node from at least the portion of the switch nodes belonging to the multicast tree, and selects and adjusts the multicast tree between the first surrogate server and the first client apparatus based on the start switch node and the optimal connecting node to establish the first transmission route.

5. The streaming service system as claimed in claim 4, wherein in the connecting node determination procedure,
the controller obtains a pending node from the check queue, and determines whether a first gap level between the pending node and the start switch node is not smaller than an optimal first gap level,
if the first gap level is not smaller than the optimal first gap level, the controller ends the connecting node determination procedure,
if the first gap level is smaller than the optimal first gap level, the controller checks an available link bandwidth between the pending node and at least one of the switch nodes connected to the pending node according to a bandwidth requirement to obtain at least one first switch node,
the controller sequentially determines whether the at least one first switch node belongs to the multicast tree,
if the controller determines that the at least one first switch node belongs to the multicast tree, the controller determines whether a second gap level between the at least one first switch node and the at least one final switch node belonging to the same multicast tree is smaller than an optimal second gap level, and when the second gap level is smaller than the optimal second gap level, the controller sets the at least one first switch node as the optimal connecting node,
if the at least one first switch node does not belong to the multicast tree, the controller takes the at least one first switch node as the pending node for being added to the check queue,
wherein when the check queue does not have the waiting pending node, the controller ends the connecting node determination procedure.

6. The streaming service system as claimed in claim 5, wherein the optimal first gap level is the first gap level between the optimal connecting node and the start switch node, the optimal second gap level is the second gap level between the optimal connecting node and the at least one final switch node belonging to the same multicast tree, and before the connecting node determination procedure is executed, the optimal first gap level and the optimal second gap level are respectively a default value.

7. The streaming service system as claimed in claim 1, wherein when the first client apparatus is joined to the streaming group, the first client apparatus further transmits a membership report message in Internet group management protocol (IGMP) to the streaming service system, and the membership report message is received by one of the switch nodes.

8. The streaming service system as claimed in claim 1, wherein when the first client apparatus leaves the streaming group, the content management apparatus informs the controller, and the controller sets at least the portion of the switch nodes to adjust the multicast tree.

9. The streaming service system as claimed in claim 8, wherein when the first client apparatus leaves the streaming group, the first client apparatus transmits an unsubscribing request to the content management apparatus, and the content management apparatus transmits a leaving request to the controller according to the unsubscribing request,
the controller receives the leaving request, and takes the switch node connected to the first client apparatus as a start switch node to execute a multicast tree pruning procedure to adjust the first transmission route of the multicast tree.

10. The streaming service system as claimed in claim 9, wherein the content management apparatus further transmits a stop request to the first surrogate server according to the unsubscribing request, such that the first surrogate server stops transmitting the streaming packets to the first client apparatus through the first transmission route of the multicast tree.

11. The streaming service system as claimed in claim 9, wherein in the multicast tree pruning procedure,
the controller determines whether the start switch node is applied to a second transmission route of the multicast tree, and the first surrogate server transmits the streaming packets to a second client apparatus through the second transmission route of the multicast tree,
if the start switch node is not applied to the second transmission route of the multicast tree, the controller excludes at least the portion of the switch nodes that are only applied to the first transmission route in the multicast tree from the multicast tree,
if the start switch node is applied to the second transmission route of the multicast tree, the controller excludes at least the portion of the switch nodes in the first transmission route that are located in an upstream of the start switch node and not applied to other branch routes of the multicast tree from the multicast tree, and the controller reconnects a downstream switch node connected to the start switch node in the second transmission route to the multicast tree to adjust the second transmission route.

12. The streaming service system as claimed in claim 9, wherein the first client apparatus further transmits a leave group message in Internet group management protocol (IGMP) to the streaming service system, and the leave group message is received by one of the switch nodes.

13. The streaming service system as claimed in claim 1, wherein the controller further selectively polls at least the portion of the switch nodes of the multicast tree to determine whether the first transmission route has a link congestion, and when the link congestion occurs in the first transmission route, the controller adjusts the first transmission route of the multicast tree.

14. A streaming service method, adapted to a streaming service system, wherein the streaming service system comprises a plurality of switch nodes that are connected, a plurality of surrogate servers respectively connected to one of the switch nodes, a content management apparatus and a controller, the controller is connected to the switch nodes and communicates with the content management apparatus, the streaming service method comprising:
providing server information of the surrogate servers to the controller by the content management apparatus;
receiving a subscribing request transmitted by a first client apparatus by the content management apparatus;
transmitting a connection request to the controller by the content management apparatus after receiving the subscribing request;
selecting a first surrogate server from the surrogate servers by the controller after receiving the connection request, and setting at least a portion of the switch nodes to adjust a multicast tree;
transmitting back a connection response to the content management apparatus by the controller; and
transmitting streaming packets to the first client apparatus by the first surrogate server through a first transmission route of the multicast tree.

15. The streaming service method as claimed in claim 14, further comprising:
transmitting a start request to the first surrogate server by the content management apparatus after receiving the connection response,
and the step of transmitting the streaming packets to the first client apparatus by the first surrogate server comprises:
transmitting the streaming packets to the first client apparatus by the first surrogate server through the first transmission route of the multicast tree after receiving the start request.

16. The streaming service method as claimed in claim 14, wherein the step of selecting the first surrogate server and adjusting the multicast tree by the controller comprises:
taking one of the switch nodes connected to the first client apparatus as a start switch node, and taking at least one of the switch nodes connected to the at least one surrogate server corresponding to the multicast tree as at least one final switch node by the controller, wherein the at least one final switch node belongs to the multicast tree;
checking whether the start switch node belongs to the multicast tree by the controller;
taking the start switch node for being added to a check queue to execute a connecting node determination procedure by the controller when the start switch node does not belong to the multicast tree;
selecting an optimal connecting node from at least the portion of the switch nodes belonging to the multicast tree by the controller after executing the connecting node determination procedure; and
selecting and adjusting the multicast tree between the first surrogate server and the first client apparatus by the controller based on the start switch node and the optimal connecting node to establish the first transmission route.

17. The streaming service method as claimed in claim 16, wherein the step of executing the connecting node determination procedure comprises:
obtaining a pending node from the check queue by the controller;
determining whether a first gap level between the pending node and the start switch node is not smaller than an optimal first gap level by the controller;
ending the connecting node determination procedure by the controller when the first gap level is not smaller than the optimal first gap level;
checking an available link bandwidth between the pending node and at least one of the switch nodes connected to the pending node according to a bandwidth requirement to obtain at least one first switch node by the controller when the first gap level is smaller than the optimal first gap level;
sequentially determining whether the at least one first switch node belongs to the multicast tree by the controller;
determining whether a second gap level between the at least one first switch node and the at least one final switch node belonging to the same multicast tree is smaller than an optimal second gap level by the controller when the at least one first switch node belongs to the multicast tree; and setting the at least one first switch node as the optimal connecting node by the controller when the second gap level is smaller than the optimal second gap level;
taking the at least one first switch node for being added to the check queue by the controller when the at least one first switch node does not belong to the multicast tree; and
ending the connecting node determination procedure by the controller when the check queue does not have the waiting pending node.

18. The streaming service method as claimed in claim 17, wherein the optimal first gap level is the first gap level between the optimal connecting node and the start switch node, the optimal second gap level is the second gap level between the optimal connecting node and the at least one final switch node belonging to the same multicast tree, and before the connecting node determination procedure is executed, the optimal first gap level and the optimal second gap level are respectively a default value.

19. The streaming service method as claimed in claim 14, further comprising:
receiving a membership report message in Internet group management protocol (IGMP) transmitted by the first client apparatus by one of the switch nodes.

20. The streaming service method as claimed in claim 14, further comprising:
receiving an unsubscribing request transmitted by the first client apparatus by the content management apparatus;
transmitting a leaving request to the controller by the content management apparatus according to the unsubscribing request; and
taking the switch node connected to the first client apparatus as a start switch node to execute a multicast tree pruning procedure to adjust the first transmission route of the multicast tree by the controller after receiving the unsubscribing request.

21. The streaming service method as claimed in claim 20, further comprising:
transmitting a stop request to the first surrogate server according to the unsubscribing request by the content management apparatus; and
stopping transmitting the streaming packets to the first client apparatus through the first transmission route of the multicast tree by the first surrogate server after receiving the stop request.

22. The streaming service method as claimed in claim 20, wherein the step of executing the multicast tree pruning procedure comprises:
determining whether the start switch node is applied to a second transmission route of the multicast tree by the controller, wherein the first surrogate server transmits the streaming packets to a second client apparatus through the second transmission route of the multicast tree;
excluding at least the portion of the switch nodes that are only applied to the first transmission route in the multicast tree from the multicast tree by the controller when the start switch node is not applied to the second transmission route of the multicast tree; and
excluding at least the portion of the switch nodes in the first transmission route that are located in an upstream of the start switch node and not applied to other branch routes of the multicast tree from the multicast tree, and reconnecting a downstream switch node connected to the start switch node in the second transmission route to the multicast tree to adjust the second transmission route by the controller when the start switch node is applied to the second transmission route of the multicast tree.

23. The streaming service method as claimed in claim 20, further comprising:
receiving a leave group message in Internet group management protocol (IGMP) transmitted by the first client apparatus by one of the switch nodes.

24. The streaming service method as claimed in claim 14, further comprising:
selectively polling at least the portion of the switch nodes of the multicast tree to determine whether the first transmission route has a link congestion by the controller; and
adjusting the first transmission route of the multicast tree by the controller when the link congestion occurs in the first transmission route.

25. A controller, adapted to a streaming service system, wherein the streaming service system comprises a plurality of switch nodes that are connected, a plurality of surrogate servers respectively connected to one of the switch nodes and a content management apparatus, the controller comprising:
a communication interface, communicates with the content management apparatus, and the switch nodes are connected to the communication interface;
a storage unit; and
a processor, coupled to the communication interface and the storage unit,
wherein the content management apparatus provides server information of the surrogate servers to the controller, and the controller stores the server information to the storage unit,
wherein when a first client apparatus is joined to a streaming group, the content management apparatus informs the controller, the processor of the controller selects a first surrogate server from the surrogate servers, and sets at least a portion of the switch nodes to adjust a multicast tree, such that the first surrogate server transmits streaming packets to the first client apparatus through a first transmission route of the multicast tree.

26. The controller as claimed in claim 25, wherein when the first client apparatus is joined to the streaming group, the controller receives a connection request from the content management apparatus through the communication interface,
after the controller receives the connection request, the processor selects the first surrogate server corresponding to the streaming group, and sets at least the portion of the switch nodes to adjust the multicast tree, and transmits back a connection response to the content management apparatus through the communication interface,
the controller further records a bandwidth requirement of the streaming group and related information of the first client apparatus and the multicast tree to the storage unit according to the connection request.

27. The controller as claimed in claim 26, wherein the processor of the controller takes one of the switch nodes connected to the first client apparatus as a start switch node, and takes at least one of the switch nodes connected to the at least one surrogate server corresponding to the multicast tree as at least one final switch node, wherein the at least one final switch node belongs to the multicast tree, and the controller checks whether the start switch node belongs to the multicast tree,
if the start switch node does not belong to the multicast tree, the processor of the controller takes the start switch node for being added to a check queue to execute a connecting node determination procedure,
the processor of the controller executes the connecting node determination procedure to select an optimal connecting node from at least the portion of the switch nodes belonging to the multicast tree, and selects and adjusts the multicast tree between the first surrogate server and the first client apparatus based on the start switch node and the optimal connecting node to establish the first transmission route.

28. The controller as claimed in claim 27, wherein the processor obtains a pending node from the check queue, and determines whether a first gap level between the pending node and the start switch node is not smaller than an optimal first gap level,
if the first gap level is not smaller than the optimal first gap level, the processor ends the connecting node determination procedure,
if the first gap level is smaller than the optimal first gap level, the processor checks an available link bandwidth between the pending node and at least one of the switch nodes connected to the pending node according to a bandwidth requirement to obtain at least one first switch node,
the processor sequentially determines whether the at least one first switch node belongs to the multicast tree,
if the processor determines that the at least one first switch node belongs to the multicast tree, the processor determines whether a second gap level between the at least one first switch node and the at least one final switch node belonging to the same multicast tree is smaller than an optimal second gap level, and when the second gap level is smaller than the optimal second gap level, the processor sets the at least one first switch node as the optimal connecting node,
if the at least one first switch node does not belong to the multicast tree, the processor takes the at least one first switch node for being added to the check queue,
wherein when the check queue does not have the waiting pending node, the processor ends the connecting node determination procedure.

29. The controller as claimed in claim 28, wherein the optimal first gap level is the first gap level between the optimal connecting node and the start switch node, the optimal second gap level is the second gap level between the optimal connecting node and the at least one final switch node belonging to the same multicast tree, and before the connecting node determination procedure is executed, the processor respectively sets the optimal first gap level and the optimal second gap level to a default value.

30. The controller as claimed in claim 25, wherein when the first client apparatus leaves the streaming group, the content management apparatus informs the controller, and the processor of the controller sets at least the portion of the switch nodes to adjust the multicast tree.

31. The controller as claimed in claim 30, wherein when the first client apparatus leaves the streaming group, the controller receives a leaving request from the content management apparatus through the communication interface,
after the controller receives the leaving request, the processor of the controller takes the switch node connected to the first client apparatus as a start switch node to execute a multicast tree pruning procedure to adjust the first transmission route of the multicast tree.

32. The controller as claimed in claim 25, wherein the processor of the controller further selectively polls at least the portion of the switch nodes of the multicast tree to determine whether the first transmission route has a link congestion, and when the link congestion occurs in the first transmission route, the processor adjusts the first transmission route of the multicast tree.
